(19) United States
(12) Patent Application Publication
(10) Pub. No.: US 2020/0275538 A1
(43) Pub. Date: Aug. 27, 2020

(54) Light-emitting Diode Lighting Fixture and Light-emitting Diode Illumination System

(71) Applicant: Superbright Lighting and Decor Limited, Hong Kong (HK)

(72) Inventor: Chuen Chiu Lau, Hong Kong (HK)

(21) Appl. No.: 16/063,702

(22) PCT Filed: Jun. 17, 2016
(86) PCT No.: PCT/CN2016/086124

§ 371 Date: Jun. 19, 2018

Related U.S. Application Data
(60) Provisional application No. 62/181,210, filed on Jun. 18, 2015.

(51) Int. Cl. H05B 45/30; H02M 7/28; H02M 7/04

(52) U.S. Cl. CPC H05B 45/30; H02M 7/043; H02M 7/28

(57) ABSTRACT

A light emitting diode (LED) lighting fixture (2), where the LED lighting fixture (2) is a discrete element including three external pins, an LED same-direction parallel circuit and a rectifier circuit are integrated inside the discrete element, an input end of the rectifier circuit is connected to the three external pins of the discrete element, and an output end of the rectifier circuit is connected to the LED same-direction parallel circuit. It is further provided an LED illumination system using the foregoing LED lighting fixture (2), including: a toroidal transformer (1) including at least one group of input ends and at least one group of output ends, each group of LED lighting fixtures (2) are directly connected to a group of output ends of the toroidal transformer. The LED lighting fixture has a simple structure and low manufacturing and use costs.

### TECHNICAL FIELD

This application relates to a light-emitting diode (LED), and in particular, to an LED lighting fixture and an LED illumination system.

### BACKGROUND

An LED is a device constituted by a single PN structure and has one-way conductivity. An LED driving circuit is a circuit for driving an LED to emit light. The LED is conventionally defined as a low-voltage direct-current product, and its driving circuit is also designed in accordance with this definition. FIG. 1 shows a typical LED driving circuit. As can be seen, the LED driving circuit includes a plurality of electronic devices such as a rectifier diode, an electrolytic capacitor, an inductor, and a chip. Consequently, an LED product has high energy consumption and a limited service life, and causes relatively much waste of devices.

### SUMMARY

The present invention provides an LED lighting fixture, where the LED lighting fixture is a discrete element including three external pins, wherein an LED same-direction parallel circuit and a rectifier circuit are integrated inside the discrete element, an input end of the rectifier circuit is connected to the three external pins of the discrete element, and an output end of the rectifier circuit is connected to the LED same-direction parallel circuit.

In an embodiment, the LED same-direction parallel circuit includes a plurality of LED parallel branches, and each of the LED parallel branches includes a plurality of LED connected in series in a same direction.

In an embodiment, the rectifier circuit includes two rectifier diodes.

In an embodiment, the two rectifier diodes are LEDs.

In an embodiment, the LED same-direction parallel circuit is further connected in parallel to a filter capacitor.

The present invention further provides an LED illumination system, including: a toroidal transformer including at least one group of input ends and at least one group of output ends and at least one group of LED lighting fixtures, where each group of output ends of the toroidal transformer includes a first voltage connector, a second voltage connector, and a common connector, a first voltage is formed between the first voltage connector and the common connector, a second voltage is formed between the second voltage connector and the common connector, the first voltage and the second voltage have a same voltage drop and opposite polarities, and the first voltage connector, the second voltage connector, and the common connector of each of the group of the output ends of the toroidal transformer are directly connected to the group of the LED lighting fixtures.

In an embodiment, the toroidal transformer is made by winding a copper coil around a toroidal core; and the toroidal core is made by seamlessly rolling a cold-rolled silicon steel sheet, the copper coil is uniformly wound around the toroidal core, and directions of lines of magnetic force generated by the copper coil completely coincide with those of the toroidal core magnetic circuit.

In an embodiment, the LED lighting fixture includes an LED circuit and a rectifier circuit, an input end of the rectifier circuit is connected to the first voltage connector, the second voltage connector, and the common connector, and an output end of the rectifier circuit is connected to the LED circuit.

In an embodiment, the LED circuit and the rectifier circuit are integrated into a single-device-type LED lighting fixture.

In an embodiment, the rectifier circuit includes two rectifier diodes, and the two rectifier diodes are LEDs.

The LED lighting fixture of the present invention has a simple structure and very low manufacturing and use costs, and is advantageous to promotion. The LED illumination system constructed from the LED lighting fixture also has very low construction and manufacturing costs.

### BRIEF DESCRIPTION OF THE DRAWINGS

FIG. 1 is a schematic diagram of an LED driving circuit according to the existing technology;

FIG. 2 is a schematic structural diagram of an LED lighting fixture according to Embodiment 1 of this application;

FIG. 3 is a diagram of a system connection structure of the LED lighting fixture according to Embodiment 1 of this application;

FIG. 4 is a diagram of a system connection structure of an LED lighting fixture according to Embodiment 2 of this application;

FIG. 5 is a waveform diagram of a point A in FIG. 3 and FIG. 4;

FIG. 6 is a waveform diagram of a point B in FIG. 3 and FIG. 4;

FIG. 7 is a waveform diagram of a point C1 in FIG. 3 and FIG. 4;

FIG. 8 is a waveform diagram of a point C2 in FIG. 3 and FIG. 4;

FIG. 9 is a waveform diagram of a point D1 in FIG. 3; and

FIG. 10 is a waveform diagram of a point D2 in FIG. 4.

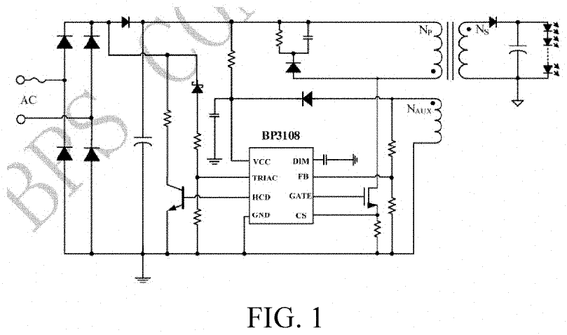

### DETAILED DESCRIPTION

The present invention is further described below in detail using specific implementations with reference to the accompanying drawings.

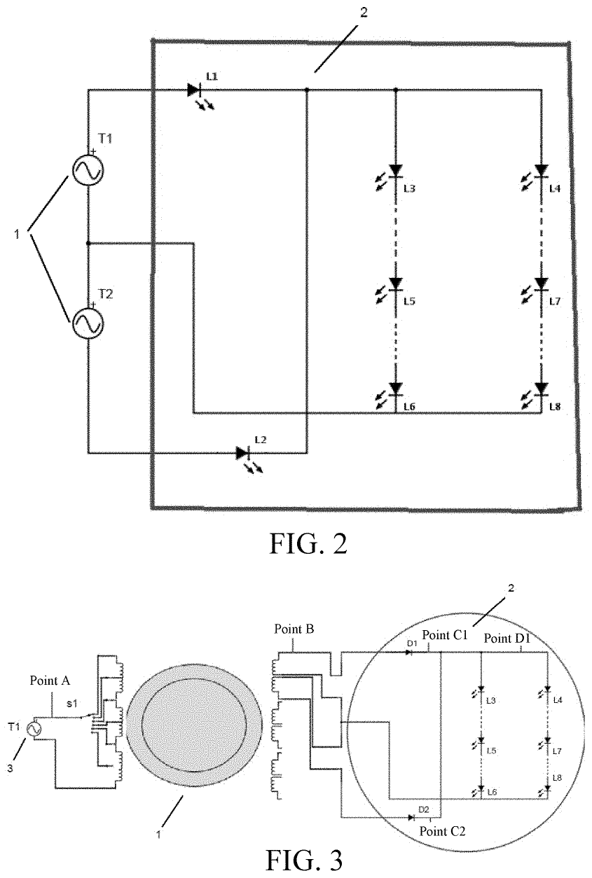

Refer to FIG. 2 to FIG. 10. In this application, an LED lighting fixture 2 used in cooperation with a toroidal transformer 1 is provided, and its design basis is: satisfying working requirements of the LED lighting fixture 2 by regulating an output voltage of the toroidal transformer 1. An LED is a low-voltage device. In this application, the toroidal transformer 1 is used to provide a low-voltage driving power supply for the LED lighting fixture 2. On the other hand, the LED is a direct-current driven device and usually needs a rectifier circuit, such as a bridge rectifier, to transform a low-voltage alternating-current voltage of the toroidal transformer 1 to a direct-current voltage. Meanwhile, the LED lighting fixture 2 of this application can be directly connected to an output voltage of the toroidal transformer 1, thereby making the circuit simpler.

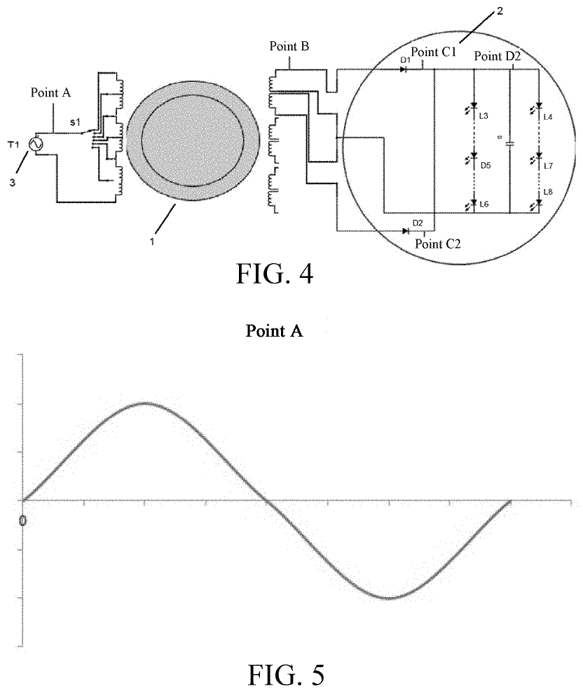

Refer to FIG. 2 to FIG. 4 for an LED illumination system of this embodiment of this application. As shown in FIG. 3 and FIG. 4, in the LED illumination system of this embodiment of this application, an alternating-current power supply 3 is connected to a primary winding (an input end) of the toroidal transformer 1, and upon voltage transformation performed by the toroidal transformer 1, a secondary winding (an output end) of the toroidal transformer 1 outputs a low-voltage alternating-current voltage needed by the LED lighting fixture 2, and the low-voltage alternating-current voltage is supplied to the LED lighting fixture 2 as a driving voltage of the LED lighting fixture 2.

As shown in FIG. 3 and FIG. 4, the toroidal transformer 1 may include at least one group of input ends and at least one group of output ends. The LED lighting fixture 2 may include an LED circuit. In this embodiment, the LED is an LED same-direction parallel circuit, and obviously, the LED may alternatively be in another form. The LED same-direction parallel circuit means that the circuit includes at least two LEDs connected in parallel in a same direction. That is, the circuit includes at least two LED branches, the two LED branch are connected in parallel, an LED is disposed in each branch, and two LEDs of the two branches are disposed in a same direction. That is, a positive electrode of an LED of one of the branches is connected to a positive electrode of an LED of another branch, and a negative electrode of an LED of one of the branches is connected to a negative electrode of an LED of another branch. In addition, each LED parallel branch in the LED same-direction parallel circuit may alternatively include a plurality of LEDs connected in series in a same direction, for example, includes three LEDs connected in series in a same direction. In this way, an LED same-direction parallel circuit includes six LEDs as shown in FIG. 2 to FIG. 4. One LED parallel branch includes LEDs L3, L5, and L6 connected in series in a same direction, and another LED parallel branch includes LEDs L4, L7, and L8 connected in series in a same direction.

Referring to FIG. 2 to FIG. 4, each LED lighting fixture 2 may alternatively include a rectifier circuit connected between an output end of the toroidal transformer 1 and the LED same-direction parallel circuit. For example, two rectifier diodes D1 and D2 may be used. Further, as shown in FIG. 2, LEDs L1 and L2 may be used as the two rectifier diodes, so that the entire LED lighting fixture 2 becomes a full-LED lighting fixture 2.

In actual industrial application, the LED lighting fixture 2 may exist as a discrete element (a single device type), and provides three pins, to directly connect to the output end of the toroidal transformer 1, without reconstructing circuits other than the LED lighting fixture 2 in the entire illumination system, to facilitate construction of the entire illumination system. That is, in the entire system, the LED lighting fixture 2 serves as a discrete device, and the toroidal transformer 1 serves as another discrete device. When the system is constructed, the output end of the toroidal transformer 1 may be directly connected to the input end of the LED lighting fixture 2, so that construction of the system is very convenient. Because three pins are provided, the LED lighting fixture 2 is referred to as a three-pin lighting fixture.

The toroidal transformer is usually applied to electrical appliances and other electronic devices having relatively high technical requirements, and is made by winding a copper coil around a toroidal core. The core of the toroidal transformer is usually made by seamlessly rolling a high-quality cold-rolled silicon steel sheet, the coil of the toroidal transformer is uniformly wound around the core, and directions of lines of magnetic force generated by the coil almost completely coincide with those of the toroidal core magnetic circuit. The toroidal transformer has high electrical efficiency and a small no-load current. The toroidal transformer has a small appearance and size, a small weight, small magnetic interference, a low operation temperature, and installation convenience. The LED illumination system of this embodiment of this application can produce the following advantageous effects:
1. Energy benefit: The toroidal transformer can reduce energy consumption, and its loss ratio is approximately lower than 3%. Compared with a DC LED using a driver, this application can save energy by 15%, and compared with a conventional MR16, this application can save energy by 70%.
2. Environmental benefit: Except for the LED, only the toroidal transformer is included. Moreover, main raw materials of the transformer are a copper wire and a core or a silicon steel sheet. A recycling ratio thereof may reach up to 70%. Compared with an existing process of disposing discarded lighting fixtures, this application may obviously reduce discarded wastes and save a great amount of labor and resource, and is environmentally-friendly.
3. Economic benefit: Using a concept of multi-connector output, a toroidal transformer can simultaneously drive a plurality of LEDs and is applicable to a lighting fixture having more connectors and higher power. The more LEDs are driven, the lower the costs are. Using 20 LEDs as an example, an economic benefit of driving 20 LEDs is greater than that of same-level design of using 20 discrete drivers.
4. The toroidal transformer has a long service life in normal use, and is particularly applicable to a site having difficulty in lighting fixture replacement, thereby greatly reducing a replacement frequency and reducing maintenance workloads.

In this application, using a toroidal transformer to drive an LED to perform illumination may greatly reduce use of electronic elements, thereby reducing costs, and on the other hand, can prolong a service life of a product, and is environmentally-friendly.

Referring to FIG. 3 and FIG. 4, the LED lighting fixture 2 of this application is driven by the toroidal transformer 1. As show in the figures, a point A is an input voltage of the toroidal transformer 1, that is, an external power supply voltage, and as shown in FIG. 5, is a zero-crossing sine wave, including a positive half cycle and a negative half cycle.

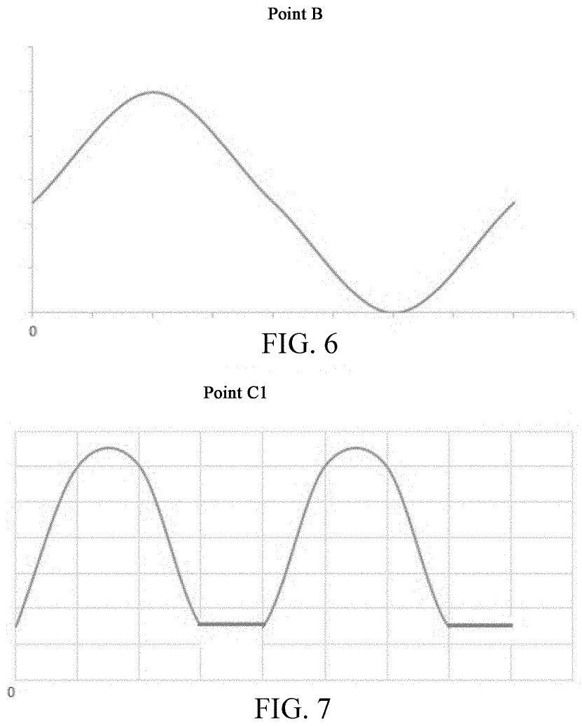

Referring to FIG. 2, when a three-pin lighting fixture of this application is connected to, two secondary windings of the toroidal transformer 1 is used to connect to the three-pin lighting fixture. One ends of the two secondary windings are respectively connected to two pins of the three-pin lighting fixture, and another ends of the two secondary windings are connected together to another pin of the three-pin lighting fixture. That is, two secondary windings together form a group of output ends of the toroidal transformer. In the group of output ends, two ends respectively connected to two pins of the three-pin lighting fixture are referred to as a first voltage connector and a second voltage connector, and ends connected together to the three-pin lighting fixture are referred to as common connectors. A first voltage is formed between the first voltage connector and the common connector, and a second voltage is formed between the second voltage connector and the common connector. The first voltage and the second voltage have a same voltage drop and opposite polarities. As can be seen, the first voltage connector, the second voltage connector, and the common connector of each group of output ends of the toroidal transformer are directly connected to a group of LED lighting fixtures. As shown in FIG. 6, after such connection is performed, a voltage of a point B on the output end of the toroidal transformer 1 is still a sine wave. However, compared with the point A, the sine wave is entirely raised relative to a zero point, and a wave peak of the negative half cycle of the sine wave at the point A is raise to the zero point of a coordinate system. Therefore, the sine wave as a whole no longer has a negative half cycle. Rather, within an entire cycle of the sine wave, the sine wave is always located above a zero axis, that is, the sine waver is positive.

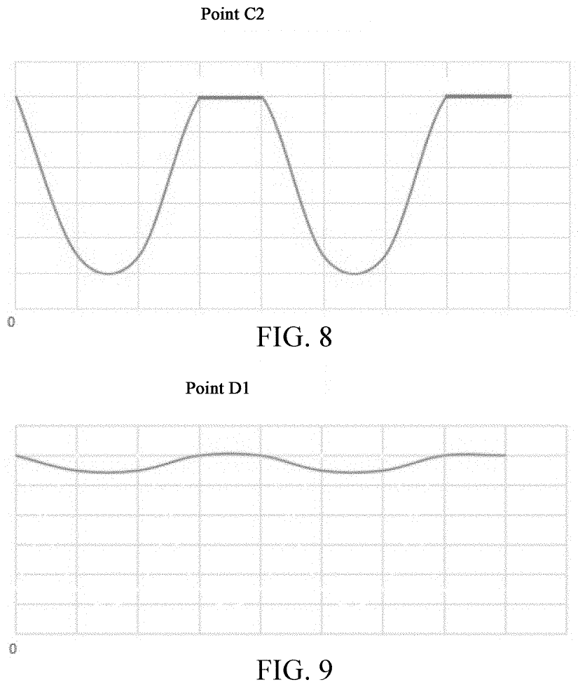

The entire positive sine wave is supplied to the three-pin lighting fixture as a driving voltage thereof. As shown in FIG. 2 to FIG. 4, the three-pin lighting fixture includes two rectifier diodes. The two rectifier diodes may be LEDs L1 and L2 shown in FIG. 2, or common diodes D1 and D2 shown in FIG. 3 and FIG. 4. As shown in FIG. 3 and FIG. 4, an output end of the diode D1 is a point C1, and an output end of the diode D2 is point C2. It is noted that the point C1 and the point C2 are actually at a same potential because of connection of a wire. However, to facilitate understanding, it is assumed that the two exist individually. That is, the point C1 is equivalent to an output when the diode D2 is disconnected, and the point C2 is equivalent to an output when the diode D1 is disconnected. In this way, an output waveform of the point C1 is shown in FIG. 7, and an output waveform of the point C2 is shown in FIG. 8. As can be seen, upon comparison between the waveform of the point C1 and the waveform of the point B, a wave valley of the waveform of the point C1 is leveled because of existence of an on-state voltage of the diode D1. That is, an input voltage lower than a diode on-state voltage is insufficient to turn on the diode and the LED lighting fixture 2 is therefore still not driven to work. It is only sufficient to drive the LED lighting fixture to work until an input voltage exceeds the diode on-stage voltage. On the other hand, compared with the waveform of the point B, the waveform of the point C2 is firstly opposite. That is, a wave peak of the point B corresponds to a wave valley of the point C2, a wave valley of the point B corresponds to the wave peak of the point C2. Other voltage points are in similar opposite correspondences. Further, as shown above, when passing through the diode D2, because of existence of the diode on-stage voltage, an input voltage lower than the diode on-stage voltage is insufficient to turn on the diode and the LED lighting fixture 2 is therefore still not driven to work. It is only sufficient to drive the LED lighting fixture to work until the input voltage exceeds the diode on-stage voltage. Hence, similar to the waveform of the point C1, a leveling effect also exists in the waveform of the point C2. However, because the leveling effect is opposite, a wave peak of the point C2 is leveled.

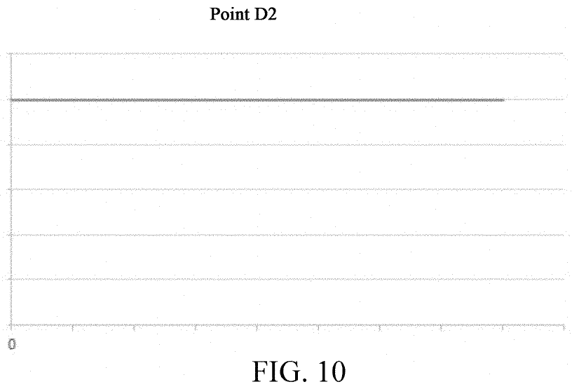

Now, considering that outputs of the diodes D1 and D2 are both connected to the LED same-direction parallel circuit, as shown in FIG. 3 and FIG. 4, the connection point is a point D1 in FIG. 3 and is a point D2 in FIG. 4. As can be seen, the point D1 and the points C1 and C2 are actually at a same potential, and a waveform at the point D1 is actually a combined waveform of the waveform of the point C1 and the waveform of the point C2. As shown in FIG. 9, because of superimposition of the waveform of the point C1 and the waveform of the point C2, the waveform of the point D1 is a basically horizontal waveform, and its amplitude is basically equivalent to a peak location of the point C1. That is, a driving voltage output to the LED same-direction parallel circuit is basically a direct-current voltage. Further, the LED same-direction parallel circuit is connected in parallel to a filter capacitor. The point D2 is a voltage output point of the filter capacitor. As shown in FIG. 10, ripples are further filtered from the waveform of the point D1, so that the waveform of the point D2 is a basically straight waveform, that is, a relatively good direct-current voltage.

The three-pin lighting fixture of this application, in terms of external structure, can be directly connected to the toroidal transformer and be further connected to an alternating-current power supply, and a circuit of its entire system is simple. Moreover, only two rectifier diodes are needed for rectification inside the three-pin lighting fixture, and an interior of the three-pin lighting fixture also has a simple and convenient circuit structure. Therefore, the three-pin lighting fixture, as a whole, has a simple structure, low costs, and favorable economic benefits, energy benefits, and environmental benefits.

Although the present invention is described by referring to specific embodiments, the embodiments are merely explanatory, and are not intended to limit the present invention. A person skilled in the art can be implicitly prompted to make various modifications and changes to the specifically disclosed exemplary embodiments. In conclusion, the scope of the present invention is not limited to the specific exemplary embodiments disclosed herein. For a person skilled in the art, all implicit modifications are included in the spirit and scope of this application and the attached claims.

What is claimed is:

1. A light emitting diode (LED) lighting fixture, wherein the LED lighting fixture is a discrete element comprising three external pins; wherein an LED same-direction parallel circuit and a rectifier circuit are integrated inside the discrete element, an input end of the rectifier circuit is connected to the three external pins of the discrete element, and an output end of the rectifier circuit is connected to the LED same-direction parallel circuit.

2. The LED lighting fixture according to claim 1, wherein the LED same-direction parallel circuit comprises a plurality of LED parallel branches, and each of the LED parallel branches comprises a plurality of LEDs connected in series in a same direction.

3. The LED lighting fixture according to claim 1, wherein the rectifier circuit comprises two rectifier diodes.

4. The LED lighting fixture according to claim 3, wherein the two rectifier diodes are LEDs.

5. The LED lighting fixture according to claim 1, wherein the LED same-direction parallel circuit is further connected in parallel to a filter capacitor.

6. A light emitting diode (LED) illumination system, comprising: a toroidal transformer comprising at least one group of input ends and at least one group of output ends, and at least one group of LED lighting fixtures; wherein each group of output ends of the toroidal transformer comprises a first voltage connector, a second voltage connector, and a common connector; a first voltage is formed between the first voltage connector and the common connector; a second voltage is formed between the second voltage connector and the common connector; the first voltage and the second voltage have a same voltage drop and opposite polarities; and the first voltage connector, the second voltage connector, and the common connector of each of the group of the output ends of the toroidal transformer are directly connected to the at least one group of the LED lighting fixtures.

7. The LED illumination system according to claim 6, wherein the toroidal transformer is made by winding a copper coil around a toroidal core; and the toroidal core is made by seamlessly rolling a cold-rolled silicon steel sheet, the copper coil is uniformly wound around the toroidal core, and directions of lines of magnetic force generated by the copper coil completely coincide with those of the toroidal core magnetic circuit.

8. The LED illumination system according to claim 6, wherein the at least one group of the LED lighting fixtures each comprises an LED circuit and a rectifier circuit, an input end of the rectifier circuit is connected to the first voltage connector, the second voltage connector, and the common connector, and an output end of the rectifier circuit is connected to the LED circuit.

9. The LED illumination system according to claim 8, wherein the LED circuit and the rectifier circuit are integrated into a single-device-type LED lighting fixture.

10. The LED illumination system according to claim 8, wherein the rectifier circuit comprises two rectifier diodes, and the two rectifier diodes are LEDs.
